(19) United States
(12) Patent Application Publication
(10) Pub. No.: US 2025/0329865 A1
(43) Pub. Date: Oct. 23, 2025

(54) DEGASSING CHANNEL ARRANGEMENT FOR A MOTOR VEHICLE AND MOTOR VEHICLE

(71) Applicant: AUDI AG, Ingolstadt (DE)

(72) Inventors: Michael BÜRCKERT, Bad Mergentheim (DE); Sebastian ENDERLE, Bad Rappenau (DE); Tomas HOVADIK, lngolstadt (DE); Thorsten KEIM, Heilbronn (DE); Markus AICHELE, Mundelsheim (DE)

(73) Assignee: AUDI AG, Ingolstadt (DE)

(21) Appl. No.: 19/175,663

(22) Filed: Apr. 10, 2025

(30) Foreign Application Priority Data
Apr. 17, 2024 (DE) 102024110809.6

(51) Int. Cl. H01M 50/342; H01M 10/613; H01M 10/625; H01M 10/6557

(52) U.S. Cl. CPC H01M 50/3425; H01M 10/6557; H01M 10/613; H01M 10/625

(57) ABSTRACT

A degassing channel arrangement with a battery module with at least one battery cell which has a releasable cell degassing opening arranged on a first cell side, a first degassing channel wall which is opposite the first cell side and which in a passage region which is opposite the releasable cell degassing opening, and a second degassing channel wall which is opposite the first degassing channel wall on a side facing away from the battery module. There is a intermediate space between the first degassing channel wall and the second degassing channel wall, A support structure arranged in the intermediate space for supporting the first degassing channel wall against the second degassing channel wall in the event of gas escaping from the releasable cell degassing opening.

### FIELD

The invention relates to a degassing channel arrangement for a motor vehicle, wherein the degassing channel arrangement comprises a battery module with at least one battery cell, which has a first cell side with a releasable cell degassing opening arranged on the first cell side. In addition, the degassing channel arrangement comprises a first degassing channel wall which is opposite the first cell side and which comprises a passage region which is opposite the releasable cell degassing opening, and a second degassing channel wall which is opposite the first degassing channel wall on a side facing away from the battery module, wherein there is an intermediate space between the first degassing channel wall and the second degassing channel wall. Furthermore, the invention also relates to a motor vehicle having such a degassing channel arrangement.

### BACKGROUND

If thermal runaway occurs in a battery cell, the excess pressure created in the battery cell can be released via a releasable cell degassing opening of such a battery cell. This can, for example, be provided in the form of a bursting membrane in the cell housing. In vehicle applications, the gases escaping from such a battery cell during thermal runaway can often be discharged via a degassing channel, which can also be provided in the form of a chamber or similar, in particular to outside the motor vehicle. The battery cells can be arranged on a first degassing channel wall with their releasable cell degassing opening facing the first degassing channel wall. The degassing channel wall comprises a passage region through which the gases exiting from the runway cell can pass to reach the intermediate space between the first degassing channel wall and the second opposite degassing channel wall. The degassing channel can be formed by the two degassing channel walls and the space between them. In this space, the gas can flow to a designated outlet opening. In addition, battery cells in a motor vehicle can be arranged with their respective cell degassing openings facing downwards. Accordingly, such a second degassing channel wall can, for example, be an underride guard for the motor vehicle. In this case, it should be ensured as reliably as possible that external forces, especially acting from below on the underride guard, cannot lead to damage to the battery cells located above.

EP 4 207 438 A1 describes a battery with multiple battery cells, which can have releasable degassing openings, a temperature control plate on which the cells are arranged and a cavity arranged below the temperature control plate for receiving gases. The intermediate space can be located between the temperature control plate and a base plate. There can also be a support element in the intermediate space to increase the pressure-bearing capacity of the intermediate space. The support element can take on various forms, for example also in the form of a honeycomb structure distributed in the intermediate space.

### SUMMARY

The object of the present invention is to provide a degassing channel arrangement and a motor vehicle which enable gases escaping from a thermally runway battery cell to be discharged as unhindered and reliably as possible via a degassing channel.

A degassing channel arrangement according to the invention comprises a battery module with at least one battery cell, which has a first cell side with a releasable cell degassing opening arranged on the first cell side, a first degassing channel wall which is opposite the first cell side and which comprises a passage region which is opposite the releasable cell degassing opening, and a second degassing channel wall which is opposite the first degassing channel wall on a side facing away from the battery module, wherein there is an intermediate space between the first degassing channel wall and the second degassing channel wall. In this case, a support structure is arranged in the intermediate space for supporting the first degassing channel wall against the second degassing channel wall in the event of gas escaping from the releasable cell degassing opening, wherein the support structure is arranged in contact with one of the two degassing channel walls in a non-deformed initial state of the first and second degassing channel walls and does not contact the other of the two degassing channel walls.

The invention is based on several findings: Firstly, in order to protect the interior of a battery housing as well as possible from environmental influences, it is advantageous to design it in such a way that as little dust or moisture or the like as possible can get into the interior of such a battery housing. Accordingly, it is advantageous to design the passage region in the first degassing channel wall as a predetermined passage region or predetermined breaking point, which is preferably fluid-tight in the undamaged normal state. If gas escapes from the releasable cell degassing opening of the battery cell, this gas can burn through the passage region of the degassing channel wall, so to speak, and thus enter the intermediate space and accordingly into the degassing channel. However, the degassing channel wall in the region of this passage region, which is still at least partially closed when the gas initially hits it, is exposed to very high pressures from the gas escaping from the battery cell. In conventional arrangements, these pressures can cause the degassing channel wall in the passage region to deform in the direction of the opposite second degassing channel wall. The intermediate space between the two degassing channel walls can also be very narrow, so that in the worst case the first degassing channel wall can even come into contact with the opposite second degassing channel wall. As a result, the passage region would be blocked by the opposite degassing channel wall and the gas would no longer be able to enter the intermediate space or would only be able to reach it with difficulty. In conventional arrangements, the escaping cell gas during thermal cell propagation can thus plastically deform the first degassing channel wall in the direction of the second degassing channel wall, which leads to a blockage of the degassing path into the intermediate space. Burning through of the passage region of the first degassing channel wall in the event of such a thermal propagation event would then no longer occur or would be made more difficult. In addition, consequential damage could possibly occur due to leaky adhesive seams forming between the cell module and the cooling module. Accordingly, it is very advantageous to provide a support between the two degassing channel walls. In order to make this as effective as possible for the degassing case described, it is accordingly desirable to be able to provide such a support structure as close as possible to the region of the first degassing channel wall opposite the releasable cell degassing opening. However, it is precisely here that there is a high risk that an external force applied to the second degassing channel wall in the direction of the first degassing channel wall will lead to damage to the battery module located above it. Especially if such an element were to be arranged in contact with both degassing channel walls and thus connecting them in order to support them against each other, this element would lead to a direct intrusion of the battery module located above it if an external force were to be applied to the second degassing channel wall in the direction of the first degassing channel wall. This risk can now advantageously be significantly reduced by arranging the support structure in contact with only one of the two degassing channel walls and having a distance to the other of the two degassing channel walls, i.e. not in contact with them. There is therefore a certain gap between the support structure on this other of the two degassing channel walls. The gap height does not have to be constant. This gap not only reduces the risk of damage to the battery module, but also has other major advantages: Firstly, this gap can also be used to compensate for tolerances. Motor vehicle batteries in particular, for example high-voltage batteries, are very large and extend in the longitudinal direction of the vehicle over a distance of, for example, 1.7 m or more. In the transverse direction of the vehicle, the battery can extend over the entire region between the two side sills. With regard to the preferred intended installation position in a motor vehicle, the first and second degassing channel walls are preferably located below the battery with respect to the vertical direction of the vehicle and extend in the longitudinal and transverse directions of the vehicle, for example also over the entire surface of the battery. The provision of a gap between the support structure and one of the two degassing channel walls enables a significantly simpler arrangement of these components relative to one another while compensating for certain component tolerances, in particular over the above-mentioned longitudinal and transverse dimensions. Joining or contacting the support structure on both degassing channel walls would increase the manufacturing and assembly costs enormously. However, joining the support structure to only one of the two degassing channel walls without providing a gap would lead to rattling noises due to vibrations, e.g. during driving. Thus, by virtue of the support structure being arranged only on one of the two degassing channel walls and not in contact with the other of the two degassing channel walls, the reliability of gas removal in the event of degassing can now be significantly increased without increasing the risk of intrusion and damage to the battery module due to such a support structure. At the same time, component and manufacturing tolerances can be compensated and rattling noises can be avoided.

A degassing channel of the degassing channel arrangement or at least a part of such a degassing channel can be formed by the two degassing channel walls and the intermediate space therebetween. The gas entering the intermediate space in the event of degassing of a cell can flow in the intermediate space, for example, to a designated outlet opening, and be discharged from there, in particular out of the motor vehicle. The degassing channel or the intermediate space with the degassing channel walls delimiting it can also be designed in the form of a chamber, in particular a large-area chamber, e.g. with dimensions as mentioned above. In addition, battery cells in a motor vehicle can be arranged with their respective cell degassing openings facing downwards. Accordingly, such a second degassing channel wall can, for example, be an underride guard for the motor vehicle.

The battery cell can be a prismatic battery cell, or a pouch cells or a round cell, for example. In particular, the battery module can also comprise multiple battery cells. In addition, the degassing channel arrangement may comprise a battery having a plurality of battery modules. Each battery module can comprise one or more battery cells. The battery can be designed, for example, as a high-voltage battery, in particular for a motor vehicle. The battery cells can be formed as lithium-ion cells, for example. The battery cells can also all be designed in the same way. This means that the features that have been and will be described for at least one battery cell can apply analogously to the other optional battery cells. The first cell side of the battery cell represents a specific side of the cell housing of the battery cell. The first cell side faces the first degassing channel wall. In particular, the first cell side can also be arranged directly on the first degassing channel wall, for example partially attached via a leveling compound, for example a so-called gap filler, also called a gap space filler, or a thermally conductive adhesive. This can further reduce the risk of deformation of the first degassing channel wall towards the second degassing channel wall in the event of degassing.

The passage region in the first degassing channel wall can be designed as already described above. This is designed in such a way that the gases escaping from the runway cell can pass through it to reach the intermediate space between the first degassing channel wall and the second opposite degassing channel wall. The passage region can be provided in the form of a predetermined breaking point or predetermined passage point which is fluid-tight when closed.

For example, the passage region can be designed as a kind of material weakening or something similar. For example, the passage region can be designed in the form of a recess in the first degassing channel wall covered with a thin film or something similar.

A releasable cell degassing opening is an opening that is closed and can be released, i.e. opened, under certain circumstances. Such a releasable cell degassing opening can therefore have a closed state and an open state and can change from the closed state to the open state. This transition does not have to be reversible. It may be that a transition from the open state to the closed state is no longer possible, e.g. in the case of a cell degassing opening designed as a bursting membrane. The releasable cell degassing opening can also be designed such that a transition from the open state to the closed state is possible, e.g. if the releasable cell degassing opening is designed as a pressure relief valve. The releasable cell degassing opening is preferably designed as a bursting element or the like.

The support structure is preferably designed such that the distance to the degassing channel wall on which the support structure is not arranged is at least 1 mm, for example 2 mm, but preferably less than 10 mm, for example less than 5 mm. Even slight deformations of the first degassing channel wall in the direction of the second degassing channel wall can thus be reliably supported by the support structure. If such a deformation occurs, the support structure can contact both degassing channel walls in this deformed state and thus support them against each other. Furthermore, the support structure can be designed in such a way that it fails above a certain force threshold value or pressure threshold value in a certain first direction, which can correspond to the vertical direction of the vehicle with respect to the preferred installation position in a motor vehicle. This ensures that a deformation of the second degassing channel wall in the direction of the first degassing channel wall due to an external force application does not lead to an intrusion of the support structure into the battery module.

Furthermore, it is preferred that the support structure is made of a material that is as temperature-resistant or temperature-stable as possible. In principle, plastics and/or metals can be considered as materials for the support structure. When it comes to metals, steel or stainless steel are particularly suitable due to their high temperature resistance. However, it is very advantageous if the support structure is made of a plastic or comprises a plastic. In particular, the support structure comprises a fire-resistant plastic or is formed from a fire-resistant plastic material, in particular a plastic material according to the V0 class. Such plastics show fire behavior according to UL94 with self-extinguishing in the event of a fire after a maximum of 10 seconds. Such a support structure is particularly suitable for withstanding the high temperatures of a gas passed through the intermediate space during degassing and for reliably supporting the degassing channel walls against each other. In particular, the material from which the support structure is made must have appropriate dimensional stability even at high temperatures. Therefore, the material of the support structure should have as high a melting point as possible. Such a preferred material is plastic, in particular, which also has low moisture absorption and medium resistance. This is particularly advantageous in “wet” installation locations, especially between an underride guard of the motor vehicle, which can provide the second degassing channel wall, and the first degassing channel wall. Furthermore, the material should be selected to provide the best compromise in terms of its stiffness (E-modulus). On the one hand, the support structure should withstand the load from the cooling module or, in general, from the first degassing channel wall in the thermal propagation case at high temperatures without collapsing; on the other hand, the collapse of the support structure in the event of an underbody load case, i.e. a deformation of the second degassing channel wall, for example the underride guard, coming from below towards the cells, for example due to bollards or gunfire, is absolutely desirable in order to cause as little cell intrusion as possible on the cells. The non-deformed initial state of the first and second degassing channel walls is the normal state of the two degassing channel walls. In this state, the degassing channel walls are considered undeformed. If these are intact and not damaged and no gas escapes from the cell, the support structure only contacts one of the two degassing channel walls and is spaced from the other of the two degassing channel walls. The contact between the support structure and both degassing channel walls simultaneously only takes place in the case in which one of the two degassing channel walls is sufficiently deformed in the direction of the other starting from its undeformed initial state, for example in the case of a deformation of the first degassing channel wall in the direction of the second degassing channel wall caused by gas escaping from the releasable cell degassing opening.

In principle, it is possible for the support structure to be arranged on the first degassing channel wall and to be at a distance from the second degassing channel wall. Alternatively, the support structure can also be arranged on the second degassing channel wall and at a distance from the first degassing channel wall. It is also conceivable that the degassing channel wall has a plurality of distributed support structures, one or more of which are arranged on the first degassing channel wall and one or more of which are arranged on the second degassing channel wall.

According to a further advantageous embodiment of the invention, the battery module comprises a cell stack with a plurality of battery cells arranged next to one another in a longitudinal direction, wherein the support structure extends in one piece or in multiple parts in the intermediate space in the longitudinal direction over several or all of the battery cells of the cell stack. This allows support to be provided by the support structure along the entire length of the battery module. This elongated design of the support structure can be designed in one piece, in particular over longer distances in the longitudinal direction, which can also be referred to as the longitudinal extension direction. This reduces the assembly effort. For example, the support structure can extend as a single component, e.g. injection-molded component, over the entire length of the battery module in the longitudinal direction, in particular over the entire length or substantially the entire length of the battery comprising the battery module. This means that only one component needs to be mounted on the corresponding degassing channel wall if the corresponding degassing channel wall is not already formed integrally with the support structure. For simplified production, especially for very long battery modules of up to 1.70 m in length, the support structure can also be designed in multiple parts. The support structure can therefore comprise multiple support structural elements which are arranged next to one another in the longitudinal direction. These can also be designed as a single-piece component and extend over several centimeters or several tens of centimeters. Thus, only a few such separate support elements are to be provided as part of the support structure in the longitudinal direction.

According to a further advantageous embodiment of the invention, the support structure comprises a first longitudinal structural element extending in the longitudinal direction, which runs in the longitudinal direction in a wave-like manner, in particular in a trapezoidal wave-like manner, so that a height of the longitudinal structural element varies in the longitudinal direction relative to that degassing channel wall on which the support structure is arranged in contact. Due to the wave-shaped course, in particular the trapezoidal wave-shaped course, the support structure can be designed to be particularly gas-permeable and yet have a very high structural rigidity and stability for supporting the degassing channel walls against each other.

The longitudinal direction extends parallel to the stacking direction of the above-mentioned cell stack. A transverse direction can be defined perpendicular to the longitudinal direction, as explained below. In addition, a vertical direction can be defined perpendicular to the longitudinal and transverse directions. The first degassing channel wall is located vertically above the second degassing channel wall and the battery module is located vertically above the first degassing channel wall. With regard to a correct installation position in a motor vehicle, the vertical direction corresponds to a vertical direction of the vehicle. The longitudinal direction preferably corresponds to a vehicle longitudinal direction and the transverse direction preferably corresponds to a vehicle transverse direction. However, the longitudinal and transverse directions can also be defined the other way around. The term “opposite”, which will be used frequently in the following, refers in particular to being opposite in relation to the vertical direction. “Opposite” can therefore be understood in the sense of a vertical projection in relation to the vertical direction, that is, in or against the vertical direction. Two regions, elements or components can also be opposite each other if there are further elements, components or regions between these two opposite elements, components or regions. The opposing components or regions do not have to be congruent but can only partially intersect or overlap in the vertical projection mentioned.

According to a further advantageous embodiment of the invention, the support structure comprises a second longitudinal structural element extending in the longitudinal direction parallel to the first longitudinal structural element, wherein the two longitudinal structural elements are arranged next to one another in a transverse direction, wherein there is an intermediate region between the two longitudinal structural elements which is opposite a cell degassing region of the battery module in which the releasable cell degassing openings of the cells comprised by the battery module are located.

By means of two longitudinal structural elements, it is advantageously possible to support the two degassing channel walls on both sides relative to the cell degassing region of the battery module located above. This means that deformation of the first degassing channel wall in the event of degassing can be prevented even more reliably. The second longitudinal structural element can be designed in the same way as already described for the first longitudinal structural element. The longitudinal structural elements can have a distance from one another in the transverse direction which is at least as large as a width of a respective releasable cell degassing opening of the battery cells comprised by the battery module.

The battery module is further preferably designed such that the releasable cell degassing openings of the battery cells comprised by the battery module are located along a line extending in the longitudinal direction. The cell degassing region can therefore essentially be understood as a rectangular region elongated in the longitudinal direction.

It is also very advantageous if no structures are arranged in the intermediate space in a region of the intermediate space opposite this cell degassing region that protrude above the support structure in the vertical direction. Also, no parts of the support structure itself should preferably be arranged opposite this degassing region. This means that the cell degassing region of the battery module is particularly well protected.

According to a further advantageous embodiment of the invention, the support structure comprises at least one transverse structural element extending in the transverse direction and connecting the two longitudinal structural elements, in particular wherein the two longitudinal structural elements and the at least one transverse structural element are designed as a one-piece component, in particular an injection-molded component.

In principle, such a transverse structural element can also be provided if it is not formed integrally with the two longitudinal structural elements. The transverse structural element can be positioned at a position described in more detail below, which allows this transverse structural element to be designed with a higher rigidity or robustness, in particular it can be positioned such that it is not opposing any cells of the battery module. The transverse structural element can be arranged in the intermediate space, for example below a housing wall of the battery housing or intermediate wall or partition wall or module housing wall or the like. Even if the transverse structural element is then pressed against the first degassing channel wall by deformation of the second degassing channel wall in the direction of the first degassing channel wall, this contact pressure is not transferred to the battery cells.

However, especially when the transverse structural element and the longitudinal structural elements are designed as a single piece, this transverse structural element has the additional advantage that it allows a more stable design of the support structure as a single piece component and a simplified arrangement and assembly. For example, multiple transverse structural elements can be provided, which are arranged for example parallel to one another and connect the two longitudinal structural elements to one another. The longitudinal structural elements and the transverse structural elements can, for example, form a kind of rectangular frame or something similar. The longitudinal structural elements and the transverse structural elements can also form a kind of ladder structure. This makes it particularly easy to manufacture a support structure shaped in this way using an injection molding process. Despite its essentially delicate structure, the support structure can be designed to be very stable for assembly and facilitates handling. In addition, the support structure does not have to be assembled in many individual parts on the corresponding degassing channel wall or, in the case of a multi-part design, the individual parts themselves can be larger.

According to a further advantageous embodiment of the invention, the cell stack is divided into several cell groups in the longitudinal direction, wherein there is a cell group intermediate space between two of the cell groups, and wherein the transverse structural element arranged in the intermediate space is opposite the cell group intermediate space, in particular located underneath it. As already mentioned above, the transverse structural element is therefore not located opposite any battery cells in the vertical direction. The risk of damage caused by intrusion can thus be reduced. This allows the transverse structural element to be designed to be significantly more robust and solid at the same time. This allows the geometry of the support element as a whole to be stiffened and allows for better support.

Furthermore, it is preferred that the transverse structural element or the optional further transverse structural elements are formed, for example, with a through-opening or recesses in the longitudinal direction, which allow flow through the transverse structural elements in the longitudinal direction. This can prevent the transverse structural elements from blocking a gas discharge path that runs longitudinally between the longitudinal structural elements.

According to a further advantageous embodiment of the invention, the first degassing channel wall has a lower side facing the second degassing channel wall, wherein the lower side has a recess in the direction of the battery module in a region opposite the cell group intermediate space, wherein the transverse structural element is arranged in the recess. In the region of the recess, the underside of the first degassing channel wall is curved in the direction of the battery module. By arranging the transverse structural element in this recess, it is advantageously possible to make the transverse structural element relatively solid in a region facing the first degassing channel wall, without blocking the degassing path described above in the longitudinal direction, since the transverse structural element can be arranged elevated with its region facing the first degassing channel wall. If the transverse structural element is arranged in particular in the region of this recess, the remaining components of the support structure are also preferably located on the first degassing channel wall. However, it is also conceivable, for example if the transverse structural elements are designed separately from the longitudinal structural elements, that they are arranged on different degassing channel walls.

Such a recess can be provided in a particularly useful manner if the first degassing channel wall is designed, for example, as a cooling plate and comprises integrated cooling channels. These serve to cool the battery cells. In regions where there are no battery cells, as is the case for example for the intermediate space between cell groups, the cooling plate also does not have to have any cooling channels or a recessed degassing channel region which is in particular opposite the releasable cell degassing openings and in which the cooling plate wall is spaced from the releasable cell degassing openings by a curvature away from the cells. This means that the cooling plate in the region below the space between the cell groups can be designed with a reduced overall wall thickness, since no cooling channels are to be provided here, and a curvature towards the bottom can also be dispensed with. In other words, the upper side of the first degassing channel wall can be flat, while the lower side reproduces the cooling channel structure of the cooling plate, as well as the above-mentioned degassing channel region, which leads to unevenness of the lower side, so that it has corresponding elevations and depressions. The transverse structural element can therefore be arranged in such a recess.

However, it is also conceivable that the transverse structural element is positioned on the second degassing channel wall and, is correspondingly opposite this recess of the first degassing channel wall.

According to a further advantageous embodiment of the invention, the first degassing channel wall is designed as a cooling plate with an integrated cooling channel arrangement comprising cooling channel portions, wherein the cooling plate has a cooling channel-free first plate region extending in the longitudinal direction, in particular running parallel to one of the cooling channel portions, wherein the first longitudinal structural element is opposite the first plate region or is arranged on it. This is particularly advantageous since the two degassing channel walls can then be supported against each other in regions, for example in the case of a deformation of the first degassing channel wall in the direction of the second degassing channel wall or of the second degassing channel wall in the direction of the first degassing channel wall, in which there are no cooling channels. Such a support does not thus entail the risk of damage to the cooling channels or deformation of the cooling channels, which would reduce the support effect. This means that support can be provided much more efficiently and reliably. The cooling channel-free region can in particular also be located between two cooling channel portions extending in the longitudinal direction. In addition, the cooling plate preferably also has such a cooling channel-free region in a region opposite the cell degassing region, which was also referred to above as the degassing channel region. A cooling channel-free region of the cooling plate can also be directly connected to this on both sides, which can be directly opposite the longitudinal structural elements or which can be adjacent to the longitudinal structural elements.

The cooling channels can in particular be designed as cavities through which a coolant can flow. The cooling channel arrangement can also be branched as desired or be complex.

According to a further advantageous embodiment of the invention, the second degassing channel wall is designed as an underride guard for a motor vehicle. The advantages of the invention and its embodiments are particularly evident when the second degassing channel wall is an underride guard. This is because it is precisely then that a reliable support of the two degassing channel walls can be provided in relation to each other in the event of degassing and the risk of damage to the battery module due to external force being applied to the second degassing channel wall can be kept very low, which occurs very frequently when the second degassing channel wall is designed as underride guard. Smaller forces acting on the underride guard therefore pose no risk of damage to the battery modules. The second degassing channel wall can generally be attached to the first degassing channel wall via additional webs, air-permeable walls or support components. These fastening points are located opposite housing parts of a battery housing, for example. Here, a bilateral contacting and fastening of the second degassing channel wall to the first degassing channel wall is possible via such a support component.

Furthermore, the invention also relates to a motor vehicle having a degassing channel arrangement according to the invention or one of its embodiments.

The advantages mentioned for the degassing channel arrangement according to the invention and its configurations thus apply similarly to the motor vehicle according to the invention.

The invention also includes developments of the motor vehicle according to the invention, which have features as already described in the context of the developments of the degassing channel arrangement according to the invention. For this reason, the corresponding developments of the motor vehicle according to the invention are not described again here.

The motor vehicle according to the invention is preferably designed as an automobile, in particular as a passenger car or truck, or as a passenger bus or motorcycle.

The invention also comprises the combinations of the features of the described embodiments. The invention therefore also comprises implementations which each have a combination of the features of several of the described embodiments, unless the embodiments have been described as mutually exclusive.

### BRIEF DESCRIPTION OF THE FIGURES

Exemplary embodiments of the invention are described hereinafter. In the figures:

FIG. 1 shows a schematic representation of a motor vehicle having a degassing channel arrangement according to an exemplary embodiment of the invention;

FIG. 2 shows a schematic representation of a part of a support structure for a degassing channel arrangement according to an exemplary embodiment of the invention;

FIG. 3 shows a schematic cross-sectional representation of a part of a degassing channel arrangement perpendicular to the transverse direction according to an exemplary embodiment of the invention; and

FIG. 4 shows a schematic cross-sectional representation of a part of a degassing channel arrangement perpendicular to the longitudinal direction according to an exemplary embodiment of the invention.

### DETAILED DESCRIPTION

The exemplary embodiments explained below are preferred embodiments of the invention. In the exemplary embodiments, the described components of the embodiments each represent individual features of the invention to be considered independently of one another, which each also develop the invention independently of one another. Therefore, the disclosure is also predetermined to comprise combinations of the features of the embodiments other than those represented. Furthermore, the described embodiments can also be supplemented by further ones of the above-described features of the invention.

In the figures, same reference numerals respectively designate elements that have the same function.

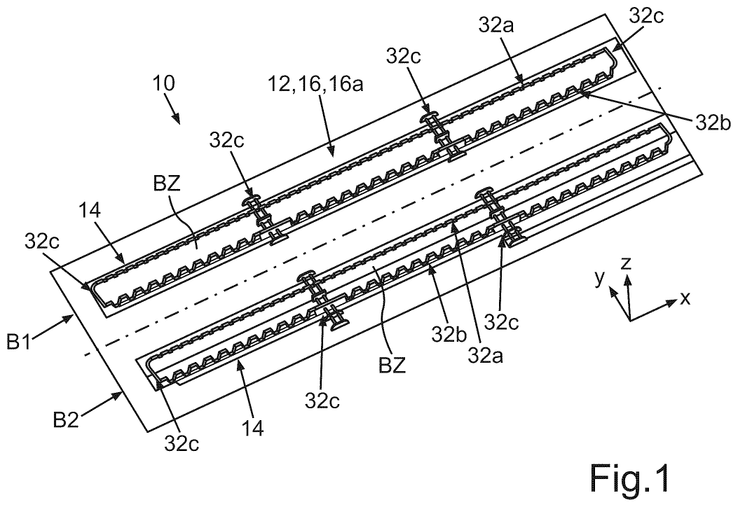

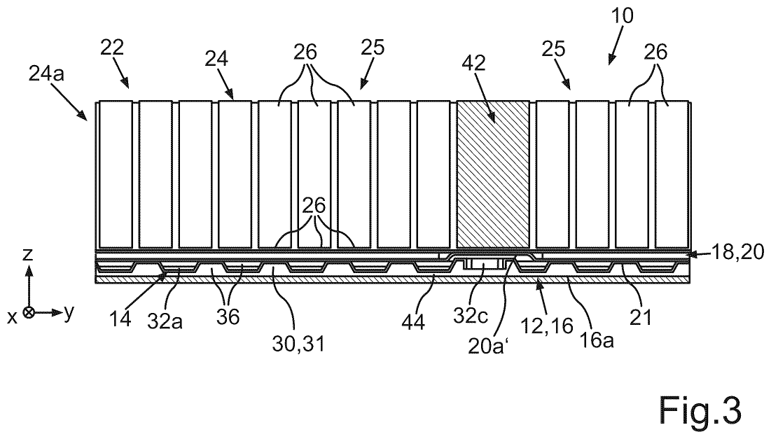

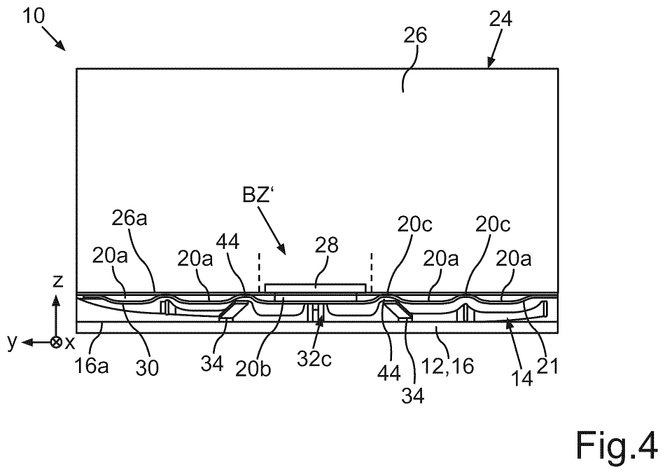

FIG. 1 shows a schematic representation of a part of a degassing channel arrangement 10 according to an exemplary embodiment of the invention. In particular, a degassing channel wall 12 with two support structures 14 arranged thereon is shown. The degassing channel wall 12 is designed as an underride guard 16. In the z-direction above the underride guard 16 and the support structures 14, a further degassing channel wall 18 in the form of a cooling plate 20 (cf. FIG. 3 and FIG. 4) is arranged, as well as a battery 22 arranged above this cooling plate 20 with one or more battery modules 24 (cf. FIG. 3) as part of the degassing channel arrangement 10.

As can be seen in FIG. 3, for example, such a battery module 24 comprises a plurality of battery cells 26, which in this example are designed as prismatic battery cells 26. As can be seen in particular in FIG. 4, each of these cells 26 comprises a first cell side 26a, which faces the cooling plate 20, which can also be referred to as cooling module 20. This respective first cell side 26a is designed with a releasable cell degassing opening 28, for example a bursting membrane, which can also be seen in FIG. 4.

If a thermal runaway of such a battery cell 26 occurs, gas escapes from such a battery cell 26 through the releasable cell degassing opening 28. With the described positioning of the cells 26, the degassing path of the cells 26 thus leads downwards, i.e. opposite to the z-direction shown, through the cooling module, namely through a certain passage region 20a of the cooling module, as illustrated in FIG. 4, into the space of the underride guard 16, more precisely into the intermediate space 30 between the two degassing channel walls 12, 18, as can also be seen in FIG. 3 and FIG. 4.

In conventional arrangements, the cooling module can be plastically deformed in the direction of the underride guard by the escaping cell gas during thermal cell propagation, which can lead to a blockage of the degassing path into the underride guard and can prevent or impede the desired burn-through of the cooling module in the passage region in the event of such a thermal event.

By means of the mentioned support structures 14, such a deformation of the cooling module 20 in the direction of the underride guard 16 can advantageously be prevented. For this purpose, an additional component, namely at least one support structure 14, which can also be referred to as a “spacer” 14 or spacer 14, is installed in the installation space 30 between the cooling module 20 and the underride guard 16 as a support function for the cooling module 20 and as a spacer between the cooling module 20 and the underride guard 16.

With the support function of the cooling module spacer 14, the deformation of the cooling module 20 in the event of thermal propagation or thermal runaway of a cell 26 can be limited. If the inherent rigidity of the cooling module 20 is not sufficient in the event of a thermal event, this spacer 14 acts as a so-called limiting blockage to prevent further deformation of the cooling module 20. Thus, an additional component, namely the at least one support structure 14, can be attached either to the underride guard 16, in particular to its upper side 16a pointing in the direction of the cooling module 20 (see FIG. 1) or alternatively to the underside 21 of the cooling module 20 (see FIG. 3).

In the example shown in FIG. 1, the respective support structures 14 are arranged as an example on the underride guard 16 or its upper side 16a. Each of these two illustrated support structures 14 corresponds in terms of its position to a battery module 24, which is located in the z-direction above the associated support structure 14. In this example, the illustrated region of the underride guard 16 with the support structures 14 arranged thereon can be divided, for example, into a first region B1 and a second region B2, the boundary of which is located on the dashed line shown as an example. The first region B1 can be located directly below a first module 24 with respect to the z-direction and the second region B2 can be located directly below a second module 24. The respective battery modules 24 can extend in the x-direction essentially over a length that corresponds to the length of the illustrated support structures 14 in the x-direction. In other words, support of the cooling plate 20 over an entire length of a respective battery module 24 should be able to be provided by means of the support structures 14. The respective spacer 14 extends in particular preferably over the entire length in the x-direction of the battery housing in which the battery modules 24 are accommodated in order to cover as many cells 26 as possible.

The underride guard 16 can have on its upper side 14 further structures, geometries or components not shown here. As a result, the two support structures 14 may be designed differently with regard to their geometry, as is the case in this case, for example. In this example, the two spacers 14 shown in FIG. 1 therefore have different geometries on their respective undersides in the direction of the underride guard 16, since the underride guard 16 in this example does not have the same geometry in the region in which the structures 14 are arranged.

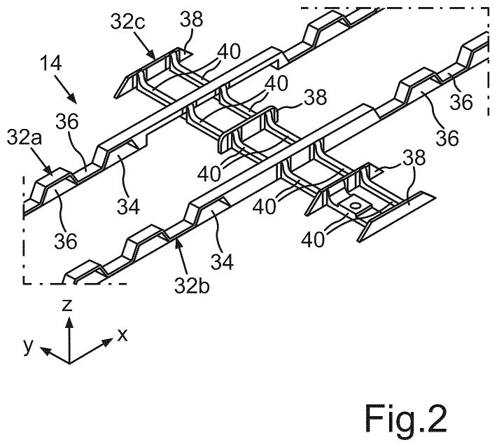

Such a support structure 14, a part of which is also illustrated in an enlarged perspective view in FIG. 2, has at least one longitudinal structural element 32a, 32b and, in the present example, two longitudinal structural elements 32a, 32b running parallel to one another in the x-direction. These run in the longitudinal direction x in a particularly wave-like manner, more precisely in a trapezoidal wave shape. In addition, such a support structure 14 comprises one or more transverse structural elements 32c. The longitudinal structural elements 32a, 32b can be connected to one another via these. In particular, such a transverse structural element 32c can also be designed in one piece with the longitudinal structural elements 32a, 32b. The two support structures 14 shown in FIG. 1 can, for example, each be manufactured as a one-piece component, for example as an injection-molded component. However, it can also be provided that each of these support structures 14 is composed of several individual components, for example 2 or 3 or 4 or more individual parts. It is preferred that such a support structure 14 is subdivided into several individual components, for example only in the x-direction. In other words, it is advantageous if two longitudinal structural elements 32a, 32b are designed as one piece with at least one transverse structural element 32c. This facilitates the handling and assembly of the support structure 14. Such a support structure 14 can, for example, be glued to one of the two degassing channel walls 12, 18 by means of an adhesive strip 34 (see FIG. 2), in the present example to the underride guard 16. There are also other fastening options. For example, if both the underride guard 16 and such a support structure 14 are made of a plastic, it is also possible to design the underride guard 16 and the support structures 14 as a single piece as an injection-molded component.

The spacer 14 is therefore attached, for example, to the underride guard 16 by means of an adhesive connection 34, for example by means of a double-sided adhesive tape 34, or adhesive. The adhesive bond is also preferably characterized by high temperature resistance when used in applications with high operating temperatures. Furthermore, it is advantageous if the adhesive connection 34 is designed in such a way that it meets requirements with regard to water, dirt and dust and does so for the lifetime of the vehicle, i.e. it maintains its adhesive function over the entire service life of the vehicle in which this degassing channel arrangement 10 is used. Stresses caused by shock and vibration should preferably also be taken into account.

In particular, the cross struts 32c are partially designed with different widths for the two support structures 14 in the y-direction, as can be seen in FIG. 1. Between each two longitudinal structures 32a, 32b of such a support structure 14 there is a region BZ which is located in the z-direction below a cell degassing region BZ′ (cf. FIG. 4), in which the respective cell degassing openings 28 of the cells 26 of the module 24 are arranged. These lie on a straight line in the x-direction. The longitudinal structures 32a, 32b are thus arranged on both sides of this region BZ, which corresponds to the degassing region BZ′. This allows a very advantageous and uniform support to be provided in the immediate vicinity of the degassing region BZ′. This provides maximum stability and support in the event of degassing through the support structures 14.

Due to their wave-shaped course, the longitudinal structures 32a, 32b are formed with free regions or passage regions 36, as can be seen in FIG. 2. A transverse structure 32c can also be designed such that it comprises support ribs 38 on the one hand, as well as connecting ribs 40 which run in the transverse direction y and connect the support ribs 38 and the longitudinal structures 32a, 32b to one another. The connecting ribs 40 can be designed to be lower in the z-direction, namely with a lower height, than the support ribs 38. This also results in possible gas passage regions in the x-direction. If a gas escaping from a cell 26 enters the intermediate space 30, i.e. the degassing channel 31 (cf. FIG. 3), this is hardly hindered during its discharge by the support structures 14, since these allow a flow through both in the transverse direction y and in the longitudinal direction x.

FIG. 3 shows a schematic cross-sectional view of a part of the degassing channel arrangement 10 perpendicular to the transverse direction or a side view looking in the transverse direction. In particular, a part of a battery module 24 is shown, which comprises a cell stack 24a that extends in the longitudinal direction. In other words, the cell stack 24a comprises a plurality of cells 26 arranged next to one another in the longitudinal direction. The cell stack 24a is also subdivided into a plurality of cell groups 25 which are separated from one another in the longitudinal direction by a cell group intermediate space 42. Components can also be located in this intermediate space 42, for example parts of the battery housing, partition walls, supporting walls or the like. The support structure 14 is preferably positioned such that the transverse structural element 32c is located below this cell group intermediate space 42, in particular in a recess 20a′ located there in the underside 21 (cf. FIG. 4) of the cooling plate 20. Here, significantly higher loads can be absorbed from below without having to fear intrusion into the cells 26, which allows the transverse structural elements 32c to be designed more robustly, for example.

In the example shown in FIG. 3, the support structure 14 is now not arranged on the underride guard 16, but instead on the degassing channel wall 18 located above it, namely the cooling plate 20. As can be seen, the support structure 14 is designed to adapt to the height of the intermediate space 30 in the z-direction such that it does not rest on the opposite degassing channel wall, namely in this case the underride guard 16, and does not contact it. There is therefore a gap 44 between the support structure 14 and the opposite degassing channel wall, in this example the underride guard 16. As described in more detail below with reference to FIG. 4, the cooling plate comprises cooling channels 24a (cf. FIG. 4), which run, for example, essentially in a straight line in the longitudinal direction, as well as cooling channel-free regions 20c (cf. FIG. 4). If the support structure 14 is arranged on the cooling plate 20, as is illustrated in this example, the support structure 14 does not contact the cooling plate 20 in the region of the cooling channels 20a, but only in the region of the cooling channel-free regions 20c. In the side view shown in FIG. 3, the support structure is therefore not located directly below the cooling channels 20c, but in this illustration behind them in the transverse direction.

FIG. 4 shows a schematic cross-sectional representation of a degassing channel arrangement 10 in a cross-section perpendicular to the longitudinal direction x or in a side view looking in the x-direction. This cross section runs through the region of a cell degassing opening 28 of a cell 26 of the module 24. In this example shown, the support element 14 is again arranged on the underride guard 16. In this case too, the support element 14 is designed in such a way that it does not come into contact with the degassing channel wall 18 located above it. Here, too, there is a gap 44 between the support element 14 and the cooling plate 20.

As can also be seen here, the cooling plate 20 also comprises cooling channels 20a. These are between two plate elements of the cooling plate 20, in particular between at least two sheet metals enclosed by the cooling plate 20. In addition, there is a recessed cooling plate region 20b below the cell degassing region BZ′. Between the cooling channels 20a there are small regions of the plate 20 in which no cooling channels 20a are arranged, and which can accordingly also be referred to as channel-free regions 20c. Also adjacent to the recessed region 20b is such a channel-free region 20c, which is not located below the cell degassing region BZ′. The support structure 14 is designed such that its highest support elements with respect to the z-direction are located directly below these channel-free regions 20c. In the event of a deformation of the cooling plate 20 in the direction of the underride guard 16, the cooling plate 20 is supported by the support structure in these channel-free regions 20c of the cooling plate 20. If the support structure is instead arranged in contact with the cooling plate itself, as in the example shown in FIG. 3, the support structure 14 is preferably also located in contact with these channel-free regions 20c and not in regions of the cooling plate 20 in which the cooling channels 20a or the recessed region 20b run. Here, too, it can be seen that the support structure 14 is glued to the underride guard 16 via an adhesive tape 34. A battery cover or module cover may be located above the module 24, but is not shown here.

In FIG. 4 it can also be seen that the spacer 14 does not lie directly on the cooling module 20, but a gap 44 has been set here. The intermediate space 44 can prevent an additional load path into the cell module 24, so that a slight deformation of the underride guard 16 in the direction of the cooling module 20 does not directly lead to cell intrusion. Furthermore, without such a gap 44, there would be a risk of acoustic noises that would be caused by the spacer 14 striking the cooling module 20 during normal driving operation. In the event of a thermal event, the spacer 14 is supported in time by the medium-carrying channels 20a of the cooling module 20, for example in the region between such a cooling channel 20a and the gas inlet channel 20b of the cooling floor 20. Due to the position, the vent element 28, i.e. the releasable cell degassing opening 28, of the cell module 24 is also protected as well as possible against possible impacts from an underfloor load case. The geometry of the spacer 14 is also selected, for example, such that in the event of an underbody load and thus the collapse of the spacer 14, i.e. a compression of the spacer with respect to the z-direction, the two cross-sectional regions, for example the sections of the wave-shaped longitudinal structural element 32a facing the underride guard 16 and the sections facing the cooling module 20, do not overlap, but come to lie next to one another and thus do not block one another. This can further minimize the risk of intrusion. This can be achieved through the wave structure described. The geometry of the spacer 14 can also be selected such that a flow in the longitudinal and transverse direction in the event of a thermal event and the support function is possible. When introducing additional support geometries in the form of the support structure 14, the gas flow within the underride guard 16 or the intermediate space 30 should not be impeded. As already described, this can be achieved by transverse ribs or connecting ribs 40 with reduced height and/or corresponding through openings 36 in the individual structural elements. In other words, this can be achieved by a corresponding local shortening of the rib height. Over the length of the component 14 in the y-direction, at the present locations, namely below the cell group intermediate region or intermediate space 42, where, for example, the end plates of the modules 24 can be located, additional support geometries and/or ribs in the form of the transverse structural elements 32c can be attached to the spacer 14 or be encompassed by it. The ribs 32c, more precisely the support ribs 38, can then support themselves on the end plates located in the space 42 and do not cause cell intrusion in the event of a underfloor load case.

Overall, the examples show how the invention can be used to implement a support function of the cooling module in the degassing concept within the battery.

1. A degassing channel arrangement, comprising: a battery module having at least one battery cell, which has a first cell side and a releasable cell degassing opening arranged on the first cell side,
a first degassing channel wall which is opposite the first cell side and which comprises a passage region which is opposite the releasable cell degassing opening, and
a second degassing channel wall which is opposite the first degassing channel wall on a side facing away from the battery module,
an intermediate space between the first degassing channel wall and the second degassing channel wall, and
a support structure arranged in the intermediate space for supporting the first degassing channel wall against the second degassing channel wall in the event of gas escaping from the releasable cell degassing opening, wherein the support structure is arranged in contact with one of the two degassing channel walls in a non-deformed initial state of the first and second degassing channel walls and does not contact the other of the two degassing channel walls.

2. The degassing channel arrangement according to claim 1, wherein the battery module comprises a cell stack with a plurality of battery cells arranged next to one another in a longitudinal direction, wherein the support structure, in one part or in multiple parts, extends in the intermediate space in the longitudinal direction over a plurality or all of the battery cells of the cell stack.

3. The degassing channel arrangement according to claim 1, wherein the support structure comprises a first longitudinal structural element extending in the longitudinal direction, which runs in the longitudinal direction in a wave-like manner, in particular in a trapezoidal wave-like manner, so that a height of the longitudinal structural element relative to the degassing channel wall on which the support structure is arranged in contact, varies in the longitudinal direction.

4. The degassing channel arrangement according to claim 1, wherein the support structure comprises a second longitudinal structural element extending in the longitudinal direction parallel to the first longitudinal structural element, wherein the two longitudinal structural elements are arranged next to one another in a transverse direction, wherein between the two longitudinal structural elements there is an intermediate region which is opposite a cell degassing region of the battery module, in which the releasable cell degassing openings of the battery cells comprised by the battery module are located.

5. The degassing channel arrangement according to claim 1, wherein the support structure comprises at least one transverse structural element extending in the transverse direction and connecting the two longitudinal structural elements, in particular wherein the two longitudinal structural elements and the at least one transverse structural element are designed as a one-piece component, in particular an injection-molded component.

6. The degassing channel arrangement according to claim 1, wherein the cell stack is subdivided longitudinally into a plurality of cell groups, wherein a cell group intermediate space is located between two of the cell groups, wherein the transverse structural element is opposite the cell group intermediate space.

7. The degassing channel arrangement according to claim 1, wherein the first degassing channel wall has a lower side facing the second degassing channel wall, wherein the lower side has a recess in the direction of the battery module in a region opposite the cell group intermediate space, wherein the transverse structural element is arranged in the recess.

8. The degassing channel arrangement according to claim 1, wherein the first degassing channel wall is designed as a cooling plate with an integrated cooling channel arrangement comprising cooling channel portions, the cooling plate having a first plate region which extends in the longitudinal direction, in particular parallel to one of the cooling channel portions and is free of cooling channels, wherein the first longitudinal structural element lies opposite the first plate region or is arranged on the latter.

9. The degassing channel arrangement according to claim 1, wherein the second degassing channel wall is designed as an underride guard.

10. A motor vehicle having a degassing channel arrangement according to claim 1.

11. The degassing channel arrangement according to claim 2, wherein the support structure comprises a first longitudinal structural element extending in the longitudinal direction, which runs in the longitudinal direction in a wave-like manner, in particular in a trapezoidal wave-like manner, so that a height of the longitudinal structural element relative to the degassing channel wall on which the support structure is arranged in contact, varies in the longitudinal direction.

12. The degassing channel arrangement according to claim 2, wherein the support structure comprises a second longitudinal structural element extending in the longitudinal direction parallel to the first longitudinal structural element, wherein the two longitudinal structural elements are arranged next to one another in a transverse direction, wherein between the two longitudinal structural elements there is an intermediate region which is opposite a cell degassing region of the battery module, in which the releasable cell degassing openings of the battery cells comprised by the battery module are located.

13. The degassing channel arrangement according to claim 3, wherein the support structure comprises a second longitudinal structural element extending in the longitudinal direction parallel to the first longitudinal structural element, wherein the two longitudinal structural elements are arranged next to one another in a transverse direction, wherein between the two longitudinal structural elements there is an intermediate region which is opposite a cell degassing region of the battery module, in which the releasable cell degassing openings of the battery cells comprised by the battery module are located.

14. The degassing channel arrangement according to claim 2, wherein the support structure comprises at least one transverse structural element extending in the transverse direction and connecting the two longitudinal structural elements, in particular wherein the two longitudinal structural elements and the at least one transverse structural element are designed as a one-piece component, in particular an injection-molded component.

15. The degassing channel arrangement according to claim 3, wherein the support structure comprises at least one transverse structural element extending in the transverse direction and connecting the two longitudinal structural elements, in particular wherein the two longitudinal structural elements and the at least one transverse structural element are designed as a one-piece component, in particular an injection-molded component.

16. The degassing channel arrangement according to claim 4, wherein the support structure comprises at least one transverse structural element extending in the transverse direction and connecting the two longitudinal structural elements, in particular wherein the two longitudinal structural elements and the at least one transverse structural element are designed as a one-piece component, in particular an injection-molded component.

17. The degassing channel arrangement according to claim 2, wherein the cell stack is subdivided longitudinally into a plurality of cell groups, wherein a cell group intermediate space is located between two of the cell groups, wherein the transverse structural element is opposite the cell group intermediate space.

18. The degassing channel arrangement according to claim 3, wherein the cell stack is subdivided longitudinally into a plurality of cell groups, wherein a cell group intermediate space is located between two of the cell groups, wherein the transverse structural element is opposite the cell group intermediate space.

19. The degassing channel arrangement according to claim 4, wherein the cell stack is subdivided longitudinally into a plurality of cell groups, wherein a cell group intermediate space is located between two of the cell groups, wherein the transverse structural element is opposite the cell group intermediate space.

20. The degassing channel arrangement according to claim 5, wherein the cell stack is subdivided longitudinally into a plurality of cell groups, wherein a cell group intermediate space is located between two of the cell groups, wherein the transverse structural element is opposite the cell group intermediate space.
